(19) United States
(12) Patent Application Publication
(10) Pub. No.: US 2022/0342767 A1
(43) Pub. Date: Oct. 27, 2022

(54) DETECTING CORRUPTION IN FOREVER INCREMENTAL BACKUPS WITH PRIMARY STORAGE SYSTEMS

(71) Applicant: EMC IP HOLDING COMPANY LLC, Hopkinton, MA (US)

(72) Inventors: Yasemin Ugur-Ozekinci, Oakville (CA); Georges Brun-Cottan, Belmont, MA (US); Ken Owens, Burlington (CA)

(73) Assignee: EMC IP HOLDING COMPANY LLC, Hopkinton, MA (US)

(21) Appl. No.: 17/235,977

(22) Filed: Apr. 21, 2021

(51) Int. Cl. G06F 11/14; G06F 11/10

(52) U.S. Cl. CPC G06F 11/1464; G06F 11/1469; G06F 11/1451; G06F 11/1461; G06F 11/1004; G06F 2201/84

(57) ABSTRACT

A storage array updates snapshots of each of a plurality of storage objects of a storage group associated with a production volume on which an application image is logically stored and sends corresponding diff's to remote backup storage. The snapshots are maintained locally on the storage array and corresponding backup snapshots are updated on the remote backup storage. The remote backup storage shares a checksum algorithm with the storage array. In response to prompting from the storage array, the remote backup storage obtains or calculates a checksum of a designated backup snapshot determined with the checksum algorithm and sends the checksum to the storage array. The storage array uses the shared checksum algorithm to calculate a comparable checksum of the corresponding local snapshot. The local and backup snapshot checksums are compared to verify the integrity of the backup snapshot.

### TECHNICAL FIELD

The subject matter of this disclosure is generally related to electronic data storage, and more particularly to verifying the integrity of “forever” snapshots.

### BACKGROUND

A storage array is an example of a high-capacity data storage system that can be used to maintain large active storage objects that are frequently accessed by multiple host servers. A storage array includes a network of specialized, interconnected compute nodes that respond to IO commands from host servers to provide access to data stored on arrays of non-volatile drives. The stored data is used by host applications that run on the host servers. Examples of host applications may include email programs, inventory control programs, and accounting programs, for example, and without limitation. Low latency data access may be required to achieve acceptable host application performance.

Cloud storage is a distinct type of storage system that is typically used in a different role than a storage array. Cloud storage exhibits greater data access latency than a storage array and may be unsuitable for servicing IOs to active storage objects. For example, host application performance would suffer if the hosts accessed data from cloud storage rather than a storage array. However, cloud storage is suitable to reduce per-bit storage costs in situations where high-performance capabilities are not required, e.g., data backup and storage of inactive or infrequently accessed data. Cloud storage and storage arrays also differ in the types of protocols used for IOs. For example, and without limitation, the storage array may utilize a transport layer protocol such as Fibre Channel, iSCSI (internet small computer system interface) or NAS (Network-Attached Storage) protocols such as NFS (Network File System), SMB (Server Message Block), CIFS (Common Internet File System) and AFP (Apple Filing Protocol). In contrast, the cloud storage may utilize any of a variety of different non-standard and provider-specific APIs (Application Programming Interfaces) such as AWS (Amazon Web Services), Dropbox, OpenStack, Google Drive/Storage APIs based on, e.g., JSON (JavaScript Object Notation).

A variety of techniques such as snapshots, backups, and replication can be implemented to avoid data loss, maintain data accessibility, and enable recreation of storage object state at a previous point in time in a storage system that includes storage arrays and cloud storage. A typical snapshot is a point-in-time representation of a storage object that includes only the changes made to the storage object relative to an earlier point in time, e.g., the time of creation of the previous snapshot. Either copy-on-write or redirect-on-write can be performed to preserve changed data that would otherwise be overwritten. Metadata indicates the relationship between the changed data and the storage object. At some regular interval, e.g., hourly, or daily, a snapshot is created by writing the changes to a snap volume. A storage array may maintain snapshots for a predetermined period of time and then discard them.

Although snapshots are typically maintained locally by a storage array, backup snapshots may be stored remotely in order to better protect against disaster events such as destruction of a storage array. For example, backup snapshots may be maintained in cloud storage or purpose-built data backup appliance that is geographically remote from the storage array, e.g., in a different data center. Storing backup snapshots in the cloud offers the advantage of low-cost storage in addition to the protection offered by geographic separation.

As the data set size is typically large, array-embedded snapshot backups to remote system only transfers the data blocks changed since the last successful backup on that remote backup storage, and then use the remote backup storage capabilities to merge the changes with the previous backup to create a new full backup. Metadata required to achieve the snapshot backups is generally more extensive and complex than for array only snapshots.

A problem arises when backups of the snapshots are implemented. Scheduled or ad-hoc created snapshot backups require transmission of data over wire, and writing to the remote system, and merging those changes with the previous base backup on the remote system. Although the storage array creates and maintains extensive metadata to assure the integrity of array only snapshots, cloud storage does not necessarily implement all of the same metadata. Corruption can occur in the data path when changes are being transferred, written, or synthesized. Consequently, corruption of incremental backup snapshots can remain undetected indefinitely.

### SUMMARY

In accordance with some implementations, a method for validating integrity and correctness of a backup snapshot of a storage object comprises providing at least one checksum algorithm to a storage array; the storage array calculating a checksum of the snapshot being backed up with the at least one checksum algorithm; calculating or retrieving a checksum of the backup of the snapshot using the same checksum algorithm; performing validation of the backup snapshot by comparing the checksum of the local snapshot being backed up with the checksum of the backup snapshot; and prompting and possibly performing remedial action in response to determining that the checksum of the local snapshot does not match the checksum of the backup snapshot.

In accordance with some implementations, a storage system comprises: remote backup storage configured to provide at least one checksum algorithm to a storage array that is configured to calculate a checksum of a snapshot being backed up with the at least one checksum algorithm, perform validation of the backup snapshot by comparing the checksum of the local snapshot being backed up with the checksum of the backup snapshot; and prompt and possibly perform remedial action in response to determining that the checksum of the local snapshot does not match the checksum of the backup snapshot.

In accordance with some implementations, a non-transitory computer-readable storage medium stores instructions that when executed by a computer cause the computer to perform a method for validating integrity and correctness of a backup snapshot of a storage object, the method comprising: providing at least one checksum algorithm to the storage array; the storage array calculating a checksum of the snapshot being backed up with the at least one checksum algorithm; calculating or retrieving a checksum of the backup of the snapshot using the same checksum algorithm; performing validation of the backup snapshot by comparing the checksum of the local snapshot being backed up with the checksum of the backup snapshot; and prompting and possibly performing remedial action in response to determining that the checksum of the local snapshot does not match the checksum of the backup snapshot.

All examples, aspects and features mentioned in this document can be combined in any technically possible way. Other aspects, features, and implementations may become apparent in view of the detailed description and figures.

### BRIEF DESCRIPTION OF THE FIGURES

FIG. 1 illustrates sharing of a checksum library and algorithms between remote backup storage and a storage array to enable generation of comparable checksums to facilitate validation of backup snapshots.

FIG. 2 illustrates the storage array in greater detail.

FIG. 3 illustrates layers of abstraction between the managed drives and the production volume.

FIG. 4 illustrates steps associated with verification of backup snapshot integrity and correctness.

### DETAILED DESCRIPTION

The terminology used in this disclosure is intended to be interpreted broadly within the limits of subject matter eligibility. The terms “disk” and “drive” are used interchangeably herein and are not intended to refer to any specific type of non-volatile storage media. The terms “logical” and “virtual” are used to refer to features that are abstractions of other features, e.g., and without limitation abstractions of tangible features. The term “physical” is used to refer to tangible features that possibly include, but are not limited to, electronic hardware. For example, multiple virtual computers could operate simultaneously on one physical computer. The term “logic” is used to refer to special purpose physical circuit elements, firmware, software, computer instructions that are stored on a non-transitory computer-readable medium and implemented by multi-purpose tangible processors, and any combinations thereof. Aspects of the inventive concepts are described as being implemented in a data storage system that includes host servers and a storage array. Such implementations should not be viewed as limiting. Those of ordinary skill in the art will recognize that there are a wide variety of implementations of the inventive concepts in view of the teachings of the present disclosure.

Some aspects, features, and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory computer-readable medium. Furthermore, it will be understood by those of ordinary skill in the art that the computer-executable instructions may be executed on a variety of tangible processor devices, i.e., physical hardware. For practical reasons, not every step, device, and component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

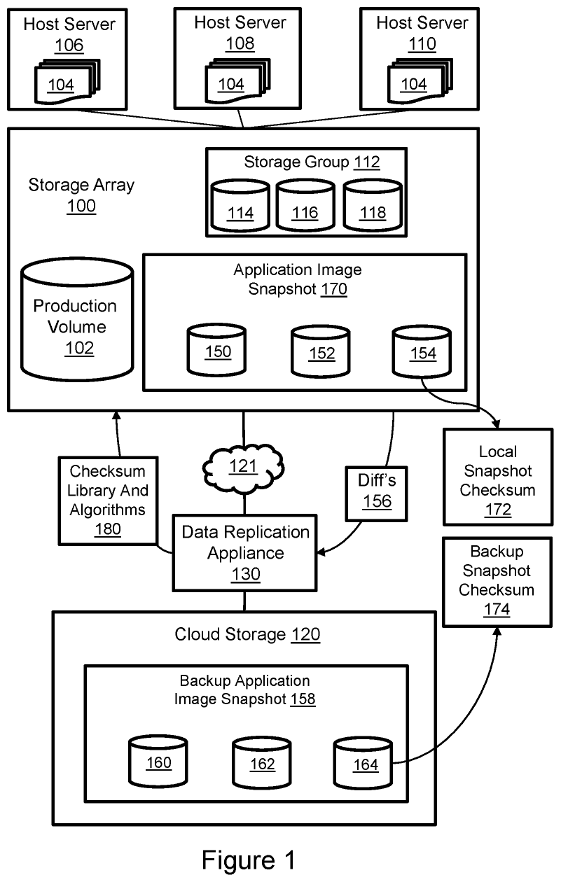

FIG. 1 illustrates sharing of a checksum library and algorithms 180 between a data backup appliance 130 and a storage array 100 to enable generation of comparable local and backup checksums 172, 174 to validate a backup snapshot from cloud storage 120 against a corresponding locally maintained snapshot. In general, a checksum is a unique representation of a data set and is smaller in size than the data set. Checksum algorithms, examples of which may include MD5, SHA-1, SHA-256, and SHA-512, use hash functions to generate relatively small values that uniquely represent a larger data set such that even minor changes to the larger data set result in generation of different checksum values. However, different checksum algorithms do not produce the same checksum from a given data set and may even produce the same checksum from different data sets. Consequently, different checksum algorithms cannot be used interchangeably, and checksums generated by different algorithms are not comparable. A checksum library contains algorithms for generating checksums. Sharing the checksum library and algorithms between the data backup appliance and the storage array enables generation of checksums of a snapshot and a corresponding backup snapshot that can be directly compared to verify the integrity of the backup snapshot.

In order to provide data storage services to the host servers 106, 108, 110, the storage array 100 creates a storage object known as a production volume 102. The production volume 102 contains a full copy of host application data, i.e., an application image. The production volume 102 is accessed by instances of a host application 104 running on each of the host servers 106, 108, 110, of which there may be many. The production volume 102 is a logical storage device that is created by the storage array using the storage resources of a storage group 112. The storage group 112 includes multiple thinly provisioned devices (TDEVs) 114, 116, 118 that are also logical storage devices. In general, logical storage devices may be referred to as logical volumes, devices, or storage objects.

An application image snapshot 170 is produced by generating respective individual snapshots 150, 152, 154 of each of the TDEVs 114, 116, 118 of the storage group associated with the production volume 102. The TDEV snapshots are stored locally by the storage array. In order to create a corresponding backup application image snapshot 158 on cloud storage 120, the storage array 100 sends data difference messages (“diff's”) 156 via network 121 to a data backup appliance 130. The diff's 156 represent changes to the production volume and thus to the snapshots 150, 152, 154 of each of the TDEVs. An individual diff is not necessarily sent for each write to the production volume 102, e.g., a diff may represent multiple updates to the production volume. The data backup appliance 130 performs deduplication and uses the diff's to prompt update of backup snapshots 160, 162, 164 of the TDEVs. In the illustrated example, backup snapshot 160 corresponds to snapshot 150, backup snapshot 162 corresponds to snapshot 152, and backup snapshot 164 corresponds to snapshot 154. The storage array maintains the local application image snapshot 170 in order to be able to recreate storage object state at any prior point in time. In a disaster recovery operation in which the application image and application image snapshot 170 become unavailable, the backup application image snapshot 158 is used to recreate the application image in a new storage group on the storage array 100 or a different storage array. For example, if storage array 100 is destroyed in a natural disaster, then the backup application image snapshot 158 can be used to rebuild the production volume 102 on a different storage array at a different data center.

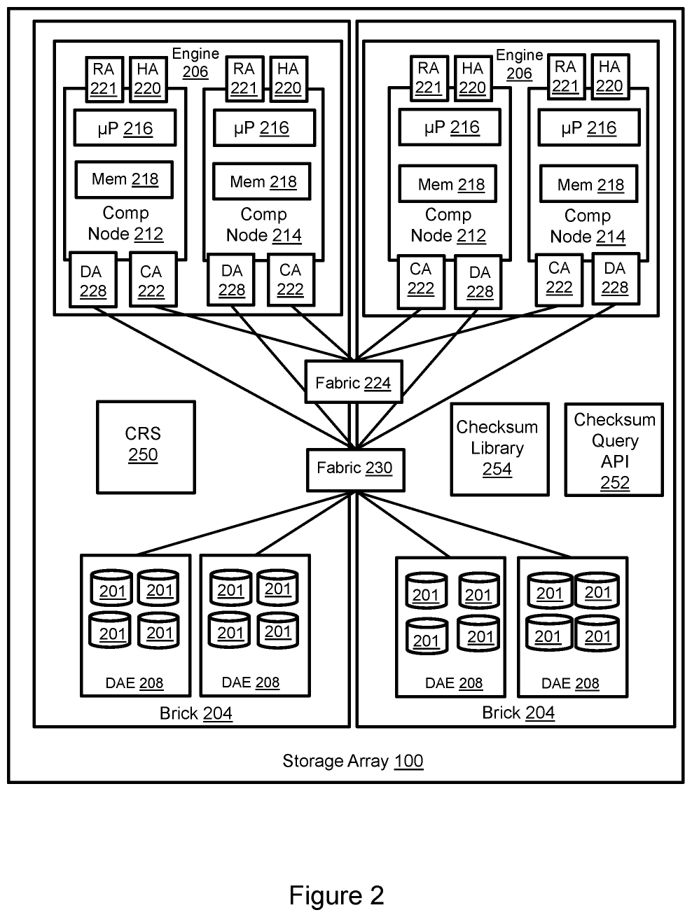

FIG. 2 illustrates the storage array 100 in greater detail. The storage array includes one or more bricks 204. Each brick includes an engine 206 and one or more drive array enclosures (DAEs) 208. Each engine 206 includes a pair of interconnected compute nodes 212, 214 that are arranged in a failover relationship and may be referred to as “storage directors.” Although it is known in the art to refer to the compute nodes of a SAN as “hosts,” that naming convention is avoided in this disclosure to help distinguish the network server hosts from the compute nodes 212, 214. Nevertheless, the host applications could run on the compute nodes, e.g., on virtual machines or in containers. Each compute node includes resources such as at least one multi-core processor 216 and local memory 218. The processor may include central processing units (CPUs), graphics processing units (GPUs), or both. The local memory 218 may include volatile media such as dynamic random-access memory (DRAM), non-volatile memory (NVM) such as storage class memory (SCM), or both. Each compute node includes one or more host adapters (HAs) 220 for communicating with the host servers. Each host adapter has resources for servicing IO commands from the host servers. The host adapter resources may include processors, volatile memory, and ports via which the hosts may access the storage array. Each compute node also includes a remote adapter (RA) 221 for communicating with other storage systems and the data backup appliance, e.g., for remote mirroring, backup, and replication. Each compute node also includes one or more drive adapters (DAs) 228 for communicating with managed drives 201 in the DAEs 208. Each drive adapter has processors, volatile memory, and ports via which the compute node may access the DAEs for servicing IOs. Each compute node may also include one or more channel adapters (CAs) 222 for communicating with other compute nodes via an interconnecting fabric 224. The managed drives 201 include non-volatile storage media such as, without limitation, solid-state drives (SSDs) based on EEPROM technology such as NAND and NOR flash memory and hard disk drives (HDDs) with spinning disk magnetic storage media. Drive controllers may be associated with the managed drives as is known in the art. An interconnecting fabric 230 enables implementation of an N-way active-active backend. A backend connection group includes all drive adapters that can access the same drive or drives. In some implementations every drive adapter 228 in the storage array can reach every DAE via the fabric 230. Further, in some implementations every drive adapter in the storage array can access every managed drive 201.

Referring to FIGS. 1 and 2, data associated with instances of the host application 104 running on the host servers 106, 108, 110 is maintained on the managed drives 201. The managed drives 201 are not discoverable by the host servers 106, 108, 110 but the production volume 102 can be discovered and accessed by the host servers. From the perspective of the host servers, the production volume 102 is a single drive having a set of contiguous fixed-size logical block addresses (LBAs) on which data used by the instances of the host application resides. However, the host application data is stored at non-contiguous addresses on various managed drives 201. The compute nodes maintain metadata that maps between the production volume 102 and the managed drives 201 in order to process IOs from the host servers.

A cloud replication system (CRS) 250 running on the storage array 100 automatically prompts transmission of the diff's 156 to the data backup appliance 130. A checksum query application programming interface (API) 252 on the storage array 100 and a corresponding API on the data backup appliance enable sharing of the checksum library and algorithms 254. The APIs also enable coordinated generation of checksums on snapshots 150, 152, 154 and backup snapshots 160, 162, 164 to verify data integrity and correctness. For example, the API 252 may be used to prompt the data backup appliance 130 to obtain or generate a checksum of a designated backup snapshot. The storage array may generate a checksum of the corresponding snapshot and then compare the generated checksum with the checksum shared by the data backup appliance.

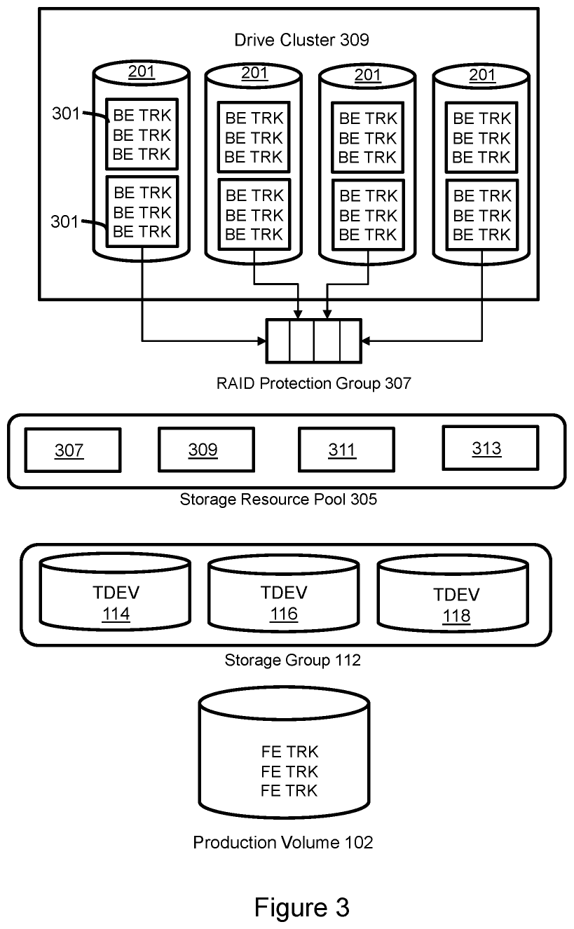

FIG. 3 illustrates layers of abstraction between the managed drives 201 and the production volume 102. The basic allocation unit of storage capacity that is used by the compute nodes to access the managed drives 201 is a back-end track (BE TRK). BE TRKs all have the same fixed size which may be an integer (greater than 1) multiple of the managed drive sector size. The managed drives 201 are each divided into capacity groupings known as “partitions,” “slices,” or “splits” 301 of equal storage capacity. Each split 301 is large enough to accommodate multiple BE TRKs. Selection of split storage capacity is a design implementation and, for context and without limitation, may be some fraction or percentage of the capacity of a managed drive equal to an integer multiple of the sector size. Each split may include a contiguous range of logical addresses. Groups of managed drives are organized into a drive cluster 309. Splits from different managed drives of a single drive cluster are used to create a RAID protection group 307. Each split in a protection group 307 is on a different managed drive. All managed drives within the cluster 309 have the same storage capacity. A storage resource pool 305 is a collection of RAID protection groups 307, 309, 311, 313 of the same type, e.g., RAID-5 (3+1) or RAID-5 (8+1). The logical thin devices (TDEVs) 114, 116, 118 are created from the storage resource pool and organized into storage group 112. The production volume 102 is created from one or more storage groups. Host application data is stored in front-end tracks (FE TRKs), that may be referred to as “blocks,” on the production volume 102. The FE TRKs on the production volume 102 are mapped to BE TRKs on the managed drives 101 by metadata. The storage array may create and maintain multiple production volumes, storage groups, storage resource pools, protection groups, and drive clusters.

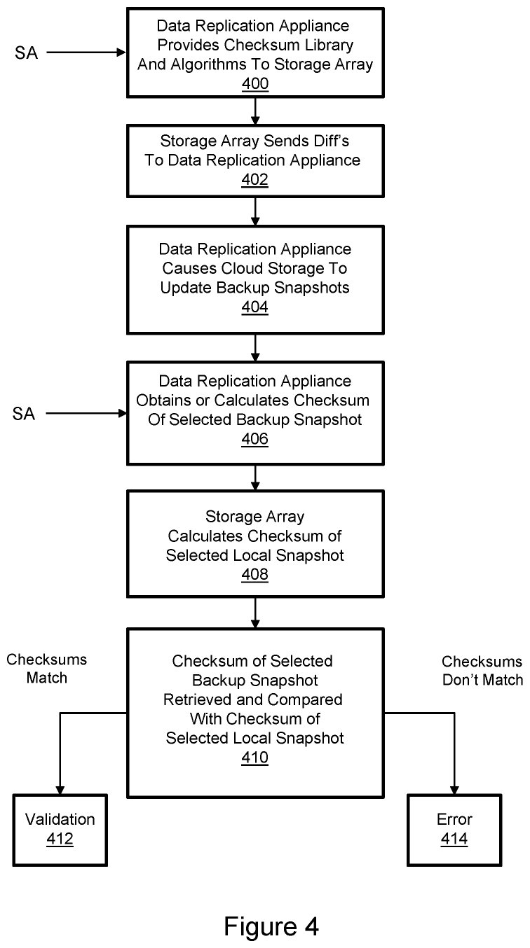

FIG. 4 illustrates steps associated with verification of backup snapshot integrity and correctness. As indicated in step 400, the data backup appliance provides a checksum library and algorithms to the storage array. The storage array (SA) or some other node may prompt the data backup appliance to provide the checksum library and algorithms. As indicated in step 402, the storage array sends diff s to the data backup appliance. Diff's may result from update of the application image, e.g., due to write IOs by the instances of the host application. The diff's are not necessarily sent on a per-write basis. As indicated in step 404, the data backup appliance uses the diff s to cause the cloud storage system to update the backup snapshots. As indicated in step 406, in response to prompting from the storage array the data backup appliance obtains or generates a checksum of a selected backup snapshot from cloud storage. The checksum is generated by the data backup appliance or cloud storage using the checksum library and algorithms shared with the storage array in step 400. The selected backup snapshot may be designated by the storage array using one or more of the storage array ID, storage group UUID, snapshot size, snapshot name, snapshot ID, volume WWN, and other metadata that is associated with the local and backup snapshots. The storage array ID is an identifier of the storage array on which the snapped storage group is located. The storage group UUID is a universally unique identifier of the snapped storage group, e.g., unique beyond the storage array. The snapshot sizes indicate the sizes of each of the snapped TDEVs of the storage group. The snapshot names indicate the names of each of the snapped TDEVs of the storage group. The snapshot IDs are the storage array locally unique identifiers of each of the snapped TDEVs of the storage group. The volume WWNs are the worldwide names of snapped TDEVs of the storage group. The checksum calculated or obtained by the data backup appliance in step 406 is sent to the storage array. The storage array calculates a checksum of the corresponding local snapshot as indicated in step 408 using the checksum library and algorithms shared in step 400. The local snapshot checksum calculated by the storage array is compared with the backup snapshot checksum calculated by cloud storage or the data backup appliance as indicated in step 410. If the local and backup snapshot checksums match, then the integrity of the backup snapshot is validated as indicated in block 412. If the local and backup snapshot checksums do not match, then the integrity of the backup snapshot is not validated, and an error is indicated as shown in block 414. Remedial action can then be initiated to correct the error, e.g., sending a copy of the local snapshot from the storage array to the data backup appliance and replacing the corrupted backup snapshot.

Specific examples have been presented to provide context and convey inventive concepts. The specific examples are not to be considered as limiting. A wide variety of modifications may be made without departing from the scope of the inventive concepts described herein. Moreover, the features, aspects, and implementations described herein may be combined in any technically possible way. Accordingly, modifications and combinations are within the scope of the following claims.

1. A method for validating integrity and correctness of a backup snapshot of a local snapshot of a storage object generated and maintained by a storage array, comprising:
providing at least one checksum algorithm to the storage array;
the storage array calculating a checksum of the local snapshot with the at least one checksum algorithm;
calculating or retrieving a checksum of the backup snapshot using the same checksum algorithm;
performing validation of the backup snapshot by comparing the checksum of the local snapshot with the checksum of the backup snapshot; and
performing remedial action to correct the backup snapshot in response to determining that the checksum of the local snapshot does not match the checksum of the backup snapshot.

2. The method of claim 1 wherein providing at least one checksum algorithm to the storage array comprises a remote backup storage providing a checksum library to the storage array.

3. The method of claim 1 comprising the storage array prompting a remote backup storage to provide the checksum algorithm.

4. The method of claim 1 comprising the storage array prompting a remote backup storage to provide the checksum of the backup snapshot.

5. The method of claim 1 comprising a remote backup storage obtaining a copy of the backup snapshot and calculating the checksum of the backup snapshot calculated with the checksum algorithm.

6. The method of claim 1 comprising a remote backup storage obtaining the checksum of the backup snapshot.

7. The method of claim 1 wherein the storage object comprises one of a plurality of thinly provisioned devices associated with the application image and comprising validating each of a plurality of backup snapshots of the thinly provisioned devices.

8. A storage system, comprising:
a remote backup storage configured to provide at least one checksum algorithm to a storage array, wherein the storage array is configured to calculate a checksum of a local snapshot of a storage object generated and maintained by the storage array with the at least one checksum algorithm, perform validation of the backup snapshot by comparing the checksum of the local snapshot with the checksum of the backup snapshot, and perform remedial action to correct the backup snapshot in response to determining that the checksum of the local snapshot does not match the checksum of the backup snapshot.

9. The storage system of claim 8 wherein the remote backup storage is configured to provide a checksum library to the storage array.

10. The storage system of claim 8 wherein the storage array is configured to prompt the remote backup storage to provide the checksum algorithm.

11. The storage system of claim 8 wherein the storage array is configured to prompt the remote backup storage to provide the checksum of the backup snapshot.

12. The storage system of claim 8 wherein the remote backup storage is configured to obtain a copy of the backup snapshot and calculate the checksum of the backup snapshot calculated with the checksum algorithm.

13. The storage system of claim 8 wherein the remote backup storage is configured to obtain the checksum of the backup snapshot.

14. The storage system of claim 8 wherein the storage object comprises one of a plurality of thinly provisioned devices associated with an application image and wherein the storage array is configured to validate each of a plurality of backup snapshots of the thinly provisioned devices.

15. A non-transitory computer-readable storage medium that stores instructions that when executed by a computer cause the computer to perform a method for validating integrity and correctness of a backup snapshot a local snapshot of a storage object generated and maintained by a storage array, the method comprising:
providing at least one checksum algorithm to the storage array;
the storage array calculating a checksum of the local snapshot with the at least one checksum algorithm;
calculating or retrieving a checksum of the backup snapshot using the same checksum algorithm;
performing validation of the backup snapshot by comparing the checksum of the local snapshot with the checksum of the backup snapshot; and
performing remedial action to correct the backup snapshot in response to determining that the checksum of the local snapshot does not match the checksum of the backup snapshot.

16. The computer-readable storage medium of claim 15 wherein the method further comprises providing a checksum library to the storage array.

17. The computer-readable storage medium of claim 15 wherein the method further comprises the storage array prompting a remote backup storage to provide the checksum algorithm.

18. The computer-readable storage medium of claim 15 wherein the method further comprises the storage array prompting a remote backup storage to provide the checksum of the backup snapshot.

19. The computer-readable storage medium of claim 15 wherein the method further comprises a remote backup storage obtaining a copy of the backup snapshot and calculating the checksum of the backup snapshot calculated with the checksum algorithm.

20. The computer-readable storage medium of claim 15 wherein the method further comprises a remote backup storage obtaining the checksum of the backup snapshot.
